(19) United States
(12) Patent Application Publication
(10) Pub. No.: US 2007/0246373 A1
(43) Pub. Date: Oct. 25, 2007

(54) INTEGRATED ELECTROCHEMICAL HYDROGEN SEPARATION SYSTEMS

(75) Inventors: Daryl L Ludlow, Rensselaer, NY (US); Glenn A Eisman, Niskayuna, NY (US); Brian C Benicewicz, Loudonville, NY (US); Michael D. Gasda, West Sand Lake, NY (US)

Correspondence Address: H2 PUMP, LLC, 11 NORTHWAY LANE NORTH, LATHAM, NY, 12110, US

(73) Assignee: H2 Pump LLC, Latham, NY (US)

(21) Appl. No.: 11/737,730

(22) Filed: Apr. 19, 2007

Related U.S. Application Data
(60) Provisional application No. 60/793,408, filed on Apr. 20, 2006.

(51) Int. Cl. B01D 53/32; C25B 9/00

(52) U.S. Cl. 205/765; 204/252

(57) ABSTRACT

Apparatus and operating methods are provided for integrated electrochemical hydrogen separation systems. In one possible embodiment, an electrical potential is applied between a first electrode and a second electrode of an electrochemical cell. The first electrode has a higher electrical potential with respect to zero than the second electrode. Electrical current is flowed through the cell as hydrogen is ionized at the first electrode and evolved at the second electrode. i.e., “pumped” across the cell. The hydrogen outlet flow and pressure from the cell can be controlled by adjusting the potential and current provided by the power supply. Various methods, features and system configurations are discussed.

### CROSS REFERENCE TO RELATED APPLICATIONS

This application claims priority under 35 USC 119(e) from U.S. Provisional Application Nos. 60/793,408, filed Apr. 20, 2006, naming Ludlow and Eisman as inventors, and titled “ELECTROCHEMICAL VALVE.” These applications are hereby incorporated herein by reference in their entirety and for all purposes.

### TECHNICAL FIELD OF THE INVENTION

The present invention relates to apparatus and operating methods for integrated electrochemical hydrogen separation systems. Various methods, features and system configurations are discussed.

### BACKGROUND

Electrochemical technologies are of increasing interest, due in part to advantages provided in efficiency and environmental impact over traditional mechanical and combustion based technologies.

A variety of electrochemical fuel cell technologies are known, wherein electrical power is produced by reacting a fuel such as hydrogen in an electrochemical cell to produce a flow of electrons across the cell, thus providing an electrical current. For example, in fuel cells utilizing proton exchange membrane technology, an electrically non-conducting proton exchange membrane is typically sandwiched between two catalyzed electrodes. One of the electrodes, typically referred to as the anode, is contacted with hydrogen. The catalyst at the anode serves to divide the hydrogen molecules into their respective protons and electrons. Each hydrogen molecule produces two protons which pass through the membrane to the other electrode, typically referred to as the cathode. The protons at the cathode react with oxygen to form water, and the residual electrons at the anode travel through an electrically conductive path around the membrane to produce an electrical current from anode to cathode. The technology is closely analogous to conventional battery technology.

Electrochemical cells can also be used to selectively transfer (or “pump”) hydrogen from one side of the cell to another. For example, in a cell utilizing a proton exchange membrane, the membrane is sandwiched between a first electrode (anode) and a second electrode (cathode), a gas containing hydrogen is placed at the first electrode, and an electric potential is placed between the first and second electrodes, the potential at the first electrode with respect to ground (or “zero”) being greater than the potential at the second electrode with respect to ground. Each hydrogen molecule reacted at the first electrode produces two protons which pass through the membrane to the second electrode of the cell, where they are rejoined by two electrons to form a hydrogen molecule (sometimes referred to as “evolving hydrogen” at the electrode).

Electrochemical cells used in this manner are sometimes referred to as hydrogen pumps. In addition to providing controlled transfer of hydrogen across the cell, hydrogen pumps can also by used to separate hydrogen from gas mixtures containing other components. Where the hydrogen is pumped into a confined space, such cells can be used to compress the hydrogen, at very high pressures in some cases.

There is a continuing need for apparatus, methods and applications relating to electrochemical cells.

### SUMMARY OF THE INVENTION

Apparatus and operating methods are provided for integrated electrochemical hydrogen separation systems. As an example, in one possible embodiment, an electrical potential is applied between a first electrode and a second electrode of an electrochemical cell. The first electrode has a higher electrical potential with respect to zero than the second electrode. Electrical current is flowed through the cell as hydrogen is ionized at the first electrode and evolved at the second electrode. i.e., “pumped” across the cell. The hydrogen outlet flow and pressure from the cell can be controlled by adjusting the potential and current provided by the power supply. Numerous optional features and system configurations are provided.

Various aspects and features of the invention will be apparent from the following Detailed Description and from the Claims.

### DESCRIPTION OF DRAWINGS

FIG. 1 is a schematic diagram illustrating one possible embodiment of an integrated electrochemical hydrogen separation system.

### DETAILED DESCRIPTION OF THE INVENTION

It will be appreciated that the apparatus, methods, and applications of the invention can include any of the features described herein, either alone or in combination.

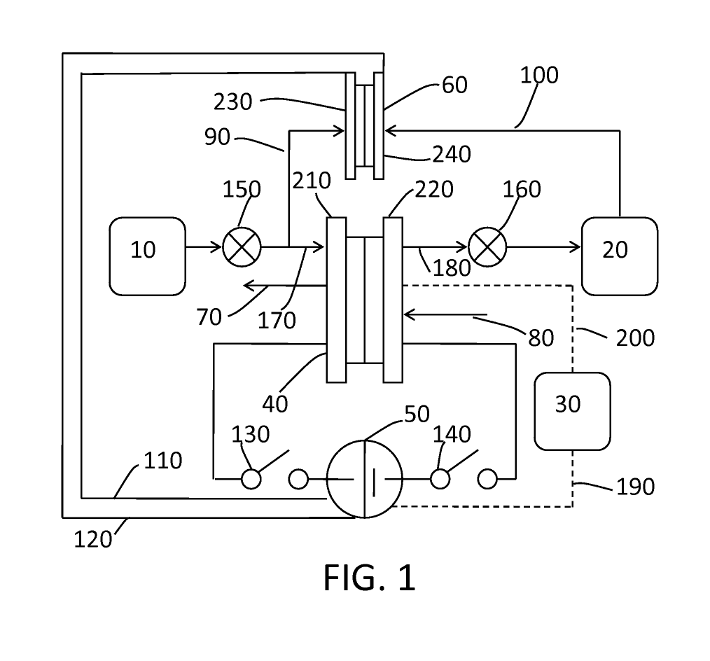

FIG. 1 is referenced in the following discussion to provide an illustration of how various features can be configured within an integrated system. It should be noted that the invention is not limited to the illustrative configuration shown in FIG. 1. Also, it will be appreciated that FIG. 1 only illustrates a limited number of the inventive features discussed herein.

In FIG. 1, an integrated electrochemical hydrogen separation system is provided. The system draws a hydrogen source gas from a vessel 10 and pumps the hydrogen across an electrochemical cell 40 where it flows to a hydrogen load 20. In this context, “vessel” refers to any conduit of hydrogen gas, such as a storage container, pressure vessel, pipeline, etc. Such a pipeline could be any source or flow of hydrogen gas or hydrogen-containing gas that can feed hydrogen to the cell 40. “Hydrogen source gas” refers to any gas containing hydrogen, whether the gas is pure hydrogen, or hydrogen is merely a dilute component of the gas, etc. The hydrogen source gas can be variously referred to as hydrogen gas, inlet hydrogen, etc. Unless otherwise indicated, the hydrogen source gas can be at any temperature or relative humidity. “Hydrogen load” refers to a storage tank, exhaust tank, pipeline, or any application configured to accept the flow of hydrogen from the cell 40.

Suitable electrochemical cell technologies are well known, such as described in the teachings of U.S. Pat. Nos. 4,620,914; 6,280,865; 7,132,182 and published U.S. patent application Ser. Nos. 10/478,852 and 11/696,179. In certain embodiments, the proton exchange membranes used under the present invention can include those based on PBI materials. Where such “high temperature” membranes are used, it is generally desirable to maintain them at an operating temperature of at least 100 C, such as 140 C or higher, or 160 C or higher.

Where PBI membranes are used, it is generally desirable to initiate operation with a membrane imbibed with phosphoric acid at a ratio of at least 20 moles phosphoric acid to polybenzimidazole repeating unit, or greater than 32 moles phosphoric acid to polybenzimidazole repeating unit, or even at least 40 moles phosphoric acid to polybenzimidazole repeating unit. It is also generally preferable that PBI materials be those formed from the sol-gel process. One advantage of PBI-based membranes is that they can generally be operated on dry gasses, where membranes such as Nafion® required humidification. In the context of the present invention, reference may be made to dry hydrogen source gas, or hydrogen source gas having less than 5% relative humidity (e.g., at the operating temperature of the cell), which is used to distinguish gasses that may not be completely dry, but are still too dry for use with membranes such as Nafion® that require humidification.

It is also generally preferable to use a proton exchange membrane having a proton conductivity that is as high as possible. For example, membranes preferred under the present invention are generally those having a proton conductivity of at least 0.1 S/cm, including those having a proton conductivity of at least 0.2 S/cm. Other proton exchange membranes can also be used with the present invention, such as Nafion®, PEEK, etc.

In the electrochemical cell 40 show in FIG. 1, the proton exchange membrane is positioned between a first electrode, 210 which is generally referred to as the anode, and a second electrode 220, which is generally referred to as the cathode. The first electrode 210 is in fluid communication with the vessel 10. In this context, “fluid communication” is used to indicate that the system is capable of providing gas flow in any manner from the vessel to the electrode.

A power supply is connected to the cell and adapted to supply electrical power by flowing current from the first electrode 210 to the second electrode 220. As an example, a positive output terminal of the power supply 50 is connected to the anode 210, and a negative output terminal of the power supply 50 is connected to the cathode 220. In the embodiment shown in FIG. 1, the electrical connections of the power supply 50 can be isolated from the cell 40 via switches 130 and 140.

Generally the power supply 50 is configured with a voltage limit and a current limit, which are output thresholds over which the power supply 50 will not exceed. In general, increases in output current from the power supply 50 will result in increases in hydrogen flow across the cell 40 (i.e., ionized at the anode and evolved at the cathode). Where the outlet hydrogen flow from the cell 40 is restricted, as with valve 160, the outlet hydrogen can be pressurized. In general, an increase in the electrical potential provided across the cell 40 by the power supply 50 will result in an increased capacity for developing a pressure differential across the cell 40, depending on the degree to which the cell cathode outlet hydrogen flow 180 is restricted.

In some embodiments, the power supply 50, can be an electrical storage device such as a battery, or can be a fuel cell, or can include such a device. In some embodiments, the power supply 50 can be adapted to receive an electrical current from the cell 40. For example, the power supply 50 can be a battery or include a battery. In order to recharge such a battery, the cell 40 can be configured to operate as a fuel cell to produce an electrical current. For example, the power supply 50 could be isolated from the cell 40, hydrogen from the hydrogen load 20 could be flowed to the second electrode 220 (now serving as a fuel cell anode), and air could be flowed to the first electrode 210 (now serving as a fuel cell cathode). It will be appreciated that all of the necessary plumbing for such a configuration is not shown in FIG. 1. For example, in such a case it might be desirable to vent the first and second cell electrodes 210 and 220.

In some embodiments, the hydrogen flow to the cell 40 can be isolated by a valve 150 between the hydrogen source gas vessel 10 and the cell anode inlet line 170. In some embodiments, the cell cathode outlet line 180 can be similarly isolated by a valve 160. In some embodiments, leftover gas is vented 70 from the anode plenum 210 as the hydrogen is removed from it in the cell 40. In this context, “plenum” refers to the conduits or spaces through which gasses flow across the electrodes. The electrode plenums are sometimes referred to synonymously with the electrodes themselves. In some embodiments, this vent 70 can also be isolated. In some embodiments, as an example, such valves can be isolation valves suitable for sealing off hydrogen flow, either manually or automatically. In other embodiments, such valves can also be one-way check valves to prevent backflow. In still other embodiments, such valves can be pressure regulators that allow flow only above a predetermined threshold.

In some embodiments, a controller 30 is provided that is adapted to energize the electrochemical cell 40 to cause hydrogen to be pumped from the first electrode 210 to the second electrode 220 as described above. The controller 30 is shown connected to the power supply 50 via signal conduit 190. The controller 30 can also be provided with the capability of measuring an amount of hydrogen flowed through the electrochemical cell 40, for example, via signal conduit 200. For example, the controller can measure the current flowed through the cell and correlate the current flow to an amount of hydrogen. The controller 30 can also be adapted to measure the pressure of the vessel 10 (configuration not shown).

The controller 30 can also be provided with a memory (not shown) adapted to receive a signal from the controller 30 to store an indication of the amount of hydrogen flowed through the electrochemical cell 40. The controller 30 can also be provided with a transmitter (not shown) adapted to transmit a signal representing the amount of hydrogen flowed through the electrochemical cell 40. Thus, the system can be controlled and monitored remotely.

In some embodiments, the controller 30 can be configured to increase the electrical power supplied to the electrochemical cell 40 by the power supply 50 to increase an outlet pressure of hydrogen at the second electrode 220. As an alternative, the controller 30 can be configured to increase the electrical power supplied to the electrochemical cell 40 to maintain an outlet pressure of hydrogen at the second electrode 220 at a predetermined level. Some embodiments can include a potentiometer or variable resistor (not shown) adapted to increase the electrical potential or power supplied to the electrochemical cell 40, either manually or automatically.

In some embodiments, the power supply 50 can configured with a switch to increase an electrical potential supplied to the electrochemical cell 40 to produce a predetermined outlet pressure of hydrogen at the second electrode 220, either automatically or in response to a signal from controller 30. In some embodiments, the controller 50 can also be configured to connect the power supply 50 to the electrochemical cell 40 for a predetermined amount of time (using a timer, for example). In some embodiments, the electrical interface between the cell 40 and the power supply 50 can include a power jack (not shown). In this context, a “power jack” refers to a electrical interface that can be selectively and removably engaged. For example, a cell could be permanently attached to a vessel or pipeline, and could be activated manually by an operator carrying a portable power supply. The “power jack” interface allows modular flexibility in the system, for example allowing cells and power supplies to be interchangeable or easily replaced, and also allowing configurations where a single power supply can be used to operate multiple systems by switching between them.

In some embodiments, as further discussed below, it can be desirable to flush the cathode plenum 220 with an inert gas, oxygen, or a gas such as air that contains oxygen. It will be appreciated that references to contacting an electrode with oxygen refer to any contact of an electrode with oxygen, whether by contacting the electrode with pure oxygen, air, etc. In the system shown in FIG. 1, an injection port 80 is provided for this purpose (a cathode vent is not shown but can be provided).

The embodiment shown in FIG. 1 uses a reference cell 60 to regulate a pressure of hydrogen at the hydrogen load 20. The reference cell 60 is an electrochemical cell similar to the pumping cell 40, but can be any type of electrochemical cell. The reference cell has a first electrode 230 and a second electrode 240. The reference cell first electrode 230 is in fluid communication with the hydrogen source gas via conduit 90, which has the effect of keeping the reference cell first electrode 230 at about the same pressure as the pumping cell anode plenum 210. The reference cell second electrode 240 is in fluid communication with the hydrogen load 20 via conduit 100, which has the effect of keeping the reference cell second electrode 240 at about the same pressure as the hydrogen load 20.

The reference cell 60 is connected to the power supply 50 (or optionally controller 30) via voltage sensing leads 110 and 120. The potential across leads 110 and 120 can be used to infer the hydrogen pressure at the hydrogen load 20. In some cases, for example where it is desirable to maintain a constant hydrogen pressure at the hydrogen load 20, such a configuration can provide an advantage over measurements of pumping cell 40 outlet pressure at the pumping cell cathode plenum 220, because there may be a lag before pressure increases reach the hydrogen load 20. The reference cell 60 can also be configured in fluid communication with any other part of the system. The system can thus be configured to vary the electrical potential applied to the electrochemical cell 40 in response to the electrical potential of the reference cell 60.

In other possible embodiments, a system can be configured with any combination of the features described herein, where the pumping cell is enclosed inside the hydrogen source vessel. As one possible example, the cell can be enclosed in a pressurized hydrogen cylinder. The cell be operated as a means of removing hydrogen from the cylinder. Because hydrogen flow across the cell is correlated to current consumption on a molecule by molecule basis, the hydrogen flow can be metered very accurately. As another possible example, a relatively low pressure hydrogen tank could be used, and the cell can be used to provide a hydrogen output at a pressure higher than the tank, eliminating the need for storing hydrogen at high pressure. One advantage of enclosing the cell in the hydrogen source gas vessel is that any hydrogen leaking from the cell is contained.

In other embodiments, integrated systems can be provided under the current invention where the cell provides the functionality discussed above, but where the cell is not enclosed in the hydrogen source gas vessel. In such cases, the cell can serve as a pressure regulator or pressure transducer to supply hydrogen to a desired application at constant pressure or flow rate.

The invention also provides methods for operation of integrated electrochemical hydrogen separation systems. As an example, in one embodiment, a method is provided for regulating hydrogen flow from a vessel, comprising: applying an electrical potential between a first electrode and a second electrode of an electrochemical cell; wherein the first electrode has a higher electrical potential with respect to zero than the second electrode; wherein the first electrode of the electrochemical cell is in fluid communication with a hydrogen source gas in the vessel; flowing electrical current through the cell to consume electrical power; ionizing hydrogen at the first electrode; evolving hydrogen at the second electrode; and increasing the electrical potential to increase an outlet pressure of the hydrogen evolved at the second electrode beyond an activation pressure of a valve in fluid communication with the second electrode. The outlet pressure of the hydrogen evolved at the second electrode can be either higher or lower than a pressure of the vessel.

In another embodiment, a method is provided for regulating hydrogen flow from a vessel, comprising: applying an electrical potential between a first electrode and a second electrode of an electrochemical cell; wherein the first electrode has a higher electrical potential with respect to zero than the second electrode; wherein the first electrode of the electrochemical cell is in fluid communication with a hydrogen source gas in the vessel; flowing electrical current through the cell to consume electrical power; ionizing hydrogen at the first electrode; evolving hydrogen at the second electrode; and modulating an amount of electrical current flowed through the cell to control an outlet flow of the hydrogen evolved at the second electrode. In this context, “modulating” refers to making any adjustment, such as turning on, off, increasing, decreasing, etc. In some embodiments, the electrical potential across the cell can be modulated, for example to control the pressure of the cell outlet, either in addition to the steps above or as an alternative to modulating the current.

As discussed above, variations on such methods can also include the step of opening a valve in fluid communication with the vessel and the first electrode, or opening a valve in fluid communication with the second electrode.

Methods can also include the steps of taking an electrical measurement from the electrochemical cell; correlating an amount of pumped hydrogen from the electrical measurement; comparing the correlated amount of pumped hydrogen to a threshold value; and generating a signal to remove the electrical potential between the first and second electrodes when the correlated amount of pumped hydrogen is at least as high as the threshold value. As previously discussed, in some embodiments, the electrical measurement comprises an amount of electrical current flowed through the cell. Additional steps may also be used, such as storing the amount of pumped hydrogen in an electrical memory circuit, and/or generating a signal representing the amount of pumped hydrogen. Such a signal can also be transmitted to a remote receiving device.

In some embodiments, methods of operating integrated electrochemical hydrogen separation systems can include the steps of flowing a predetermined amount of electrical current through the cell; and removing the electrical potential between the first and second electrodes when the predetermined amount of electrical current has been met.

In the methods described herein, where cell current or potential is modulated, the modulation can be achieved by various means, including modulating an electrical circuit in response to a control signal. As one example, such a circuit could be a switch, actuated either manually or automatically. Where cell potential is modulated, it can be achieved in some embodiments by actuating a potentiometer. In some cases, cell potential can also be modulated manually by connecting a mobile power supply to the first and second electrodes of the cell.

Where methods include a step of flowing electrical current through the cell to consume electrical power, in some cases such steps can include utilizing a fuel cell to generate electrical current or charge for use by a pumping cell.

Where methods include a step of flowing electrical current through the cell to consume electrical power, such methods can include additional prior steps of removing the electrical potential between the first electrode and the second electrode; contacting the second electrode with oxygen; connecting an electrical load between the first electrode and the second electrode; flowing a fuel cell mode electrical current from the first electrode to the electrical load; storing at least a portion of the fuel cell mode electrical current in an electrical storage device; removing the electrical load between the first electrode and the second electrode; and connecting the electrical storage device to the first electrode and the second electrode to supply the electrical potential.

Methods can also includes the use of a reference cell as previously discussed to monitor and control system performance. For example, methods may include measuring an electrical potential of a reference cell, wherein the reference cell has a first reference electrode and a second reference electrode, wherein the first reference electrode is in fluid communication with the first electrode of the electrochemical cell, and the second reference electrode is in fluid communication with the second electrode of the electrochemical cell. Such methods may further include varying the electrical potential applied to the electrochemical cell in response to the electrical potential measured from the reference cell. It will be appreciated that the reference cell can be in fluid communication with any part of the hydrogen flow within the system. For example, the second reference electrode can be in fluid communication with a hydrogen reservoir adapted to receive hydrogen from the second electrode of the electrochemical cell.

In another embodiment, methods under the present invention can include applying an electrical load between a first electrode and a second electrode of an electrochemical cell; wherein the first electrode of the electrochemical cell is in fluid communication with a hydrogen source gas in the vessel, and wherein the second electrode of the electrochemical cell is in contact with hydrogen; ionizing hydrogen at the first electrode; and evolving hydrogen at the second electrode. In this context, the “load” is any electrical connection that will remove electrical current. As an example, this can refer to shorting the cell, or operation of the cell as a fuel cell. By applying the electrical load, operation of the cell will be driven by the hydrogen partial pressure gradient across the cell membrane.

Whereas the embodiments and features discussed herein are generally described with respect to individual electrochemical cells, it will be appreciated that they are also applicable to cells grouped in stack configurations. Descriptions and claims as to the configuration and operation of individual cells can thus be taken to cover cells by themselves, or a cell forming part of a stack configuration.

The inventive concepts discussed in the claims build on traditional electrochemical cells technologies that are well known in the art. As examples, various suitable designs and operating methods that can be used as a base to implement the present invention are described in the teachings of U.S. Pat. Nos. 4,620,914; 6,280,865; 7,132,182 and published U.S. patent application Ser. Nos. 10/478,852 and 11/696,179, which are each hereby incorporated by reference in their entirety.

While the invention has been shown or described in only some of its forms, it should be apparent to those skilled in the art that it is not so limited, but is susceptible to various changes without departing from the scope of the invention.

We claim:

1. A method of regulating hydrogen flow from a vessel, comprising:
applying an electrical potential between a first electrode and a second electrode of an electrochemical cell;
wherein the first electrode has a higher electrical potential with respect to zero than the second electrode;
wherein the first electrode of the electrochemical cell is in fluid communication with a hydrogen source gas in the vessel;
flowing electrical current through the cell to consume electrical power;
ionizing hydrogen at the first electrode;
evolving hydrogen at the second electrode; and
increasing the electrical potential to increase an outlet pressure of the hydrogen evolved at the second electrode beyond an activation pressure of a valve in fluid communication with the second electrode.

2. The method of claim 1, wherein the outlet pressure of the hydrogen evolved at the second electrode is higher than a pressure of the vessel.

3. The method of claim 1, wherein the outlet pressure of the hydrogen evolved at the second electrode is lower than a pressure of the vessel.

4. A method of regulating hydrogen flow from a vessel, comprising:
applying an electrical potential between a first electrode and a second electrode of an electrochemical cell;
wherein the first electrode has a higher electrical potential with respect to zero than the second electrode;
wherein the first electrode of the electrochemical cell is in fluid communication with a hydrogen source gas in the vessel;
flowing electrical current through the cell to consume electrical power;
ionizing hydrogen at the first electrode;
evolving hydrogen at the second electrode; and
modulating an amount of electrical current flowed through the cell to control an outlet flow of the hydrogen evolved at the second electrode.

5. The method of claim 4, further comprising:
opening a valve in fluid communication with the vessel and the first electrode.

6. The method of claim 4, further comprising:
opening a valve in fluid communication with the second electrode.

7. The method of claim 4, wherein the first and second electrodes have an acid doped polybenzimidazole membrane between them.

8. The method of claim 4, wherein the hydrogen at the first electrode has a relative humidity less than 5% at the operating temperature of the cell.

9. The method of claim 4, further comprising:
maintaining a temperature of the first electrode over 100 C.

10. The method of claim 4, further comprising:
taking an electrical measurement from the electrochemical cell;
correlating an amount of pumped hydrogen from the electrical measurement;
comparing the correlated amount of pumped hydrogen to a threshold value; and
generating a signal to remove the electrical potential between the first and second electrodes when the correlated amount of pumped hydrogen is at least as high as the threshold value.

11. The method of claim 10, wherein the electrical measurement comprises an amount of electrical current flowed through the cell.

12. The method of claim 4, further comprising:
modulating the electrical potential to control an outlet pressure of hydrogen evolved at the second electrode.

13. The method of claim 4, further comprising:
taking an electrical measurement from the electrochemical cell;
correlating an amount of pumped hydrogen from the electrical measurement; and
storing the amount of pumped hydrogen in an electrical memory circuit.

14. The method of claim 4, further comprising:
taking an electrical measurement from the electrochemical cell;
correlating an amount of pumped hydrogen from the electrical measurement; and
generating a signal representing the amount of pumped hydrogen.

15. The method of claim 14, further comprising:
transmitting the signal to a remote receiving device.

16. The method of claim 4, further comprising:
flowing a predetermined amount of electrical current through the cell; and
removing the electrical potential between the first and second electrodes when the predetermined amount of electrical current has been met.

17. The method of claim 4, wherein the electrical potential is applied by modulating an electrical circuit in response to a control signal.

18. The method of claim 4, wherein the electrical potential is applied by modulating a switch.

19. The method of claim 4, wherein the electrical potential is applied by actuating a potentiometer.

20. The method of claim 4, wherein the electrical potential is applied by manually connecting a mobile power supply to the first and second electrodes.

21. The method of claim 4, wherein the step of flowing electrical current through the cell to consume electrical power comprises utilizing a fuel cell to generate electrical current.

22. The method of claim 4, further comprising the following steps, conducted prior to the step of flowing electrical current through the cell to consume electrical power:
removing the electrical potential between the first electrode and the second electrode;
contacting the second electrode with oxygen;
connecting an electrical load between the first electrode and the second electrode;
flowing a fuel cell mode electrical current from the first electrode to the electrical load;
storing at least a portion of the fuel cell mode electrical current in an electrical storage device;
removing the electrical load between the first electrode and the second electrode; and
connecting the electrical storage device to the first electrode and the second electrode to supply the electrical potential.

23. The method of claim 4, further comprising:
measuring an electrical potential of a reference cell, wherein the reference cell has a first reference electrode and a second reference electrode, wherein the first reference electrode is in fluid communication with the first electrode of the electrochemical cell, and the second reference electrode is in fluid communication with the second electrode of the electrochemical cell.

24. The method of claim 23, further comprising:
varying the electrical potential applied to the electrochemical cell in response to the electrical potential measured from the reference cell.

25. The method of claim 23, wherein the second reference electrode is in fluid communication with a hydrogen reservoir adapted to receive hydrogen from the second electrode of the electrochemical cell.

26. A method of regulating hydrogen flow from a vessel, comprising:
applying an electrical potential between a first electrode and a second electrode of an electrochemical cell;
wherein the first electrode has a higher electrical potential with respect to zero than the second electrode;
wherein the first electrode of the electrochemical cell is in fluid communication with a hydrogen source gas in the vessel;
flowing electrical current through the cell to consume electrical power;
ionizing hydrogen at the first electrode;
evolving hydrogen at the second electrode; and
modulating the electrical potential to control an outlet pressure of the hydrogen evolved at the second electrode.

27. The method of claim 26, further comprising:
opening a valve in fluid communication with the vessel and the first electrode.

28. The method of claim 26, further comprising:
opening a valve in fluid communication with the second electrode.

29. The method of claim 26, wherein the first and second electrodes have an acid doped polybenzimidazole membrane between them.

30. The method of claim 26, wherein the hydrogen at the first electrode has a relative humidity less than 5% at the operating temperature of the cell.

31. The method of claim 26, further comprising:
maintaining a temperature of the first electrode over 100 C.

32. The method of claim 26, further comprising:
taking an electrical measurement from the electrochemical cell;
correlating an amount of pumped hydrogen from the electrical measurement;
comparing the correlated amount of pumped hydrogen to a threshold value; and
generating a signal to remove the electrical potential between the first and second electrodes when the correlated amount of pumped hydrogen is at least as high as the threshold value.

33. The method of claim 32, wherein the electrical measurement comprises an amount of electrical current flowed through the cell.

34. The method of claim 26, further comprising:
modulating the electrical current flowed through the cell to control an outlet flow of hydrogen evolved at the second electrode.

35. The method of claim 26, further comprising:
taking an electrical measurement from the electrochemical cell;
correlating an amount of pumped hydrogen from the electrical measurement; and
storing the amount of pumped hydrogen in an electrical memory circuit.

36. The method of claim 26, further comprising:
taking an electrical measurement from the electrochemical cell;
correlating an amount of pumped hydrogen from the electrical measurement; and
generating a signal representing the amount of pumped hydrogen.

37. The method of claim 36, further comprising:
transmitting the signal to a remote receiving device.

38. The method of claim 26, further comprising:
flowing a predetermined amount of electrical current through the cell; and
removing the electrical potential between the first and second electrodes when the predetermined amount of electrical current has been met.

39. The method of claim 26, wherein the electrical potential is applied by modulating an electrical circuit in response to a control signal.

40. The method of claim 26, wherein the electrical potential is applied by modulating a switch.

41. The method of claim 26, wherein the electrical potential is applied by actuating a potentiometer.

42. The method of claim 26, wherein the electrical potential is applied by manually connecting a mobile power supply to the first and second electrodes.

43. The method of claim 26, wherein the step of flowing electrical current through the cell to consume electrical power comprises utilizing a fuel cell to generate electrical current.

44. The method of claim 26, further comprising the following steps, conducted prior to the step of flowing electrical current through the cell to consume electrical power:
removing the electrical potential between the first electrode and the second electrode;
contacting the second electrode with oxygen;
connecting an electrical load between the first electrode and the second electrode;
flowing a fuel cell mode electrical current from the first electrode to the electrical load;
storing at least a portion of the fuel cell mode electrical current in an electrical storage device;
removing the electrical load between the first electrode and the second electrode; and
connecting the electrical storage device to the first electrode and the second electrode to supply the electrical potential.

45. The method of claim 26, further comprising:
measuring an electrical potential of a reference cell, wherein the reference cell has a first reference electrode and a second reference electrode, wherein the first reference electrode is in fluid communication with the first electrode of the electrochemical cell, and the second reference electrode is in fluid communication with the second electrode of the electrochemical cell.

46. The method of claim 45, further comprising:
varying the electrical potential applied to the electrochemical cell in response to the electrical potential measured from the reference cell.

47. The method of claim 45, wherein the second reference electrode is in fluid communication with a hydrogen reservoir adapted to receive hydrogen from the second electrode of the electrochemical cell.

48. A method of regulating hydrogen flow from a vessel, comprising:
applying an electrical load between a first electrode and a second electrode of an electrochemical cell;
wherein the first electrode of the electrochemical cell is in fluid communication with a hydrogen source gas in the vessel, and wherein the second electrode of the electrochemical cell is in contact with hydrogen;
ionizing hydrogen at the first electrode; and
evolving hydrogen at the second electrode.

49. An integrated electrochemical hydrogen separation system, comprising:
a vessel containing hydrogen gas;
an electrochemical cell comprising a proton exchange membrane positioned between a first electrode and a second electrode;
wherein the first electrode is in fluid communication with the vessel;
a power supply adapted to supply electrical power to the electrochemical cell by flowing current from the first electrode to the second electrode; and
a valve in fluid communication with the second electrode.

50. The system of claim 49, further comprising:
a check valve positioned in fluid communication between the vessel and the first electrode.

51. The system of claim 49, wherein the proton exchange membrane is an acid doped polybenzimidazole membrane.

52. The system of claim 49, further comprising a heater adapted to maintain the proton exchange membrane at a temperature of at least 100 C.

53. The system of claim 49, wherein the hydrogen gas has a relative humidity less than 5% at the operating temperature of the cell.

54. The system of claim 49, further comprising a controller adapted to energize the electrochemical cell to cause hydrogen to be pumped from the first electrode to the second electrode.

55. The system of claim 49, further comprising a controller adapted to measure an amount of hydrogen flowed through the electrochemical cell.

56. The system of claim 55, further comprising a memory adapted to receive a signal from the controller to store an indication of the amount of hydrogen flowed through the electrochemical cell.

57. The system of claim 55, further comprising a transmitter adapted to transmit a signal representing the amount of hydrogen flowed through the electrochemical cell.

58. The system of claim 49, further comprising a controller adapted to increase the electrical power supplied to the electrochemical cell to increase an outlet pressure of hydrogen at the second electrode.

59. The system of claim 49, further comprising a controller adapted to increase the electrical power supplied to the electrochemical cell to maintain an outlet pressure of hydrogen at the second electrode at a predetermined level.

60. The system of claim 49, further comprising a potentiometer adapted to increase the electrical power supplied to the electrochemical cell.

61. The system of claim 49, further comprising a switch adapted to increase an electrical potential supplied to the electrochemical cell to produce a predetermined outlet pressure of hydrogen at the second electrode.

62. The system of claim 49, further comprising a controller adapted to connect the power supply to the electrochemical cell for a predetermined amount of time.

63. The system of claim 49, further comprising a power jack through which the power supply is adapted to be connected to the electrochemical cell.

64. The system of claim 49, further comprising an injection port in fluid communication with the second electrode.

65. The system of claim 49, wherein the power supply is an electrical storage device.

66. The system of claim 49, wherein the electrical storage device is adapted to receive an electrical current from the cell.

67. The system of claim 49, wherein the electrochemical cell is enclosed inside the vessel.

68. The system of claim 49, further comprising:
a reference cell, wherein the reference cell has a first reference electrode and a second reference electrode, wherein the first reference electrode is in fluid communication with the first electrode of the electrochemical cell, and the second reference electrode is in fluid communication with the second electrode of the electrochemical cell.

69. The system of claim 68, wherein the power supply is adapted to vary the electrical potential applied to the electrochemical cell in response to the electrical potential of the reference cell.

70. The system of claim 68, wherein the second reference electrode is in fluid communication with a hydrogen reservoir adapted to receive hydrogen from the second electrode of the electrochemical cell.

71. An integrated electrochemical hydrogen separation system, comprising:
a vessel containing hydrogen gas;
an electrochemical cell comprising a proton exchange membrane positioned between a first electrode and a second electrode;
wherein the first electrode is in fluid communication with the vessel;
a power supply adapted to supply electrical power to the electrochemical cell by flowing current from the first electrode to the second electrode; and
a controller adapted to energize the electrochemical cell to cause hydrogen to be pumped from the first electrode to the second electrode.

72. An integrated electrochemical hydrogen separation system, comprising:
a vessel containing hydrogen gas;
an electrochemical cell comprising a proton exchange membrane positioned between a first electrode and a second electrode;
wherein the first electrode is in fluid communication with the vessel;
a power supply adapted to supply electrical power to the electrochemical cell by flowing current from the first electrode to the second electrode; and
a controller adapted to measure an amount of hydrogen flowed through the electrochemical cell.

73. An integrated electrochemical hydrogen separation system, comprising:
a vessel containing hydrogen gas;
an electrochemical cell comprising a proton exchange membrane positioned between a first electrode and a second electrode;
wherein the first electrode is in fluid communication with the vessel;
a power supply adapted to supply electrical power to the electrochemical cell by flowing current from the first electrode to the second electrode; and
a controller adapted to measure a pressure of the vessel.

74. An integrated electrochemical hydrogen separation system, comprising:
a vessel containing hydrogen gas;
an electrochemical cell comprising a proton exchange membrane positioned between a first electrode and a second electrode;
wherein the first electrode is in fluid communication with the vessel;
a power supply adapted to supply electrical power to the electrochemical cell by flowing current from the first electrode to the second electrode;
an storage tank adapted to receive hydrogen evolved from the second electrode; and
a controller adapted to measure a pressure of the storage tank.
